(19) United States
(12) Patent Application Publication
(10) Pub. No.: US 2013/0009896 A1
(43) Pub. Date: Jan. 10, 2013

(54) 3D FINGER POSTURE DETECTION AND GESTURE RECOGNITION ON TOUCH SURFACES

(75) Inventor: Vadim ZALIVA, Saratoga, CA (US)

(73) Assignee: Lester F. LUDWIG, Belmont, CA (US)

(21) Appl. No.: 13/544,960

(22) Filed: Jul. 9, 2012

Related U.S. Application Data
(60) Provisional application No. 61/506,096, filed on Jul. 9, 2011.

(51) Int. Cl. G06F 3/041

(52) U.S. Cl. 345/173

(57) ABSTRACT

The invention provides 3D touch gesture recognition on touch surfaces incorporating finger posture detection and includes a touch user interface device in communication with a processing device. The interface device includes a sensor array for sensing spatial information of one or more regions of contact and provides finger contact information in the form of a stream of frame data. A frame is read from the sensor array, subjected to thresholding, normalization, and feature extraction operations to produce a features vector. A multi-dimensional gesture space is constructed having desired set of features, each represented by a space dimension. A gesture trajectory is a sequence of transitions between pre-calculated clusters, and when a specific gesture trajectory is detected, a control signal is generated.

### CROSS-REFERENCE TO RELATED APPLICATIONS

Pursuant to 35 U.S.C. §119(e), this application claims benefit of priority from Provisional U.S. Patent application Ser. No. 61/506,096, filed Jul. 9, 2011, the contents of which are incorporated by reference.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

The invention relates to gesture recognition on touch surfaces, and more specifically to 3D finger posture detection in the recognition of gestures with 3D characteristics.

Touch surfaces are becoming more prevalent in today's technology, appearing as touch screens on mobile and stationary devices, laptop touchpads, electronic books, computer mice, etc. They find uses in many diverse areas such as manufacturing and medical systems, assistive technologies, entertainment, human-robot interaction and others. Significant progress in touch-sensitive hardware has been made in recent years, making available on the market touch sensors which are smaller, longer lasting, more accurate and more affordable than predecessors. With these technological advancements, gesture-based interfaces are certain to become more prevalent as gestures are among the most primary and expressive form of human communications [42].

However modern models of gesture interaction on touch surfaces remain relatively rudimentary. Companies like Apple and Microsoft are gradually introducing in their products gesture metaphors, but they are still limited to abstract gestures like “two-finger swipe” or primitive metaphors such as “pinch to zoom”. However, significant additional progress can be made in the area of gesture recognition, allowing for the introduction of more complex gesture metaphors, and thus more complex interaction scenarios.

One contributing factor currently hindering the introduction of richer gestures is the simplistic 2D interaction model employed in mouse, trackball, and touch user interface devices. Essentially all modern touch interfaces consider only the planar finger contact position with the touchpad, limiting themselves to measurement of a pair of coordinates for each finger application. A notable exception is the work by New Renaissance Institute, related to the real-time extraction of 3D posture information from tactile images [29, 15, 25]. Using 3D finger posture rather than just 2D contact point in gesture definition opens the door to very rich, expressive, and intuitive gesture metaphors. These can be added to touchpads, touch screens, and can be implemented on the back of a mouse [27, 18].

The present invention accordingly addresses gesture recognition on touch surfaces incorporating 3D finger posture detection so as to implement recognition of gestures with 3D characteristics.

### SUMMARY

For purposes of summarizing, certain aspects, advantages, and novel features are described herein. Not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

The invention provides for gesture recognition on touch surfaces incorporating 3D finger posture detection to implement recognition of gestures with 3D characteristics.

In one aspect of the invention, a system for 3D gesture recognition on touch surfaces comprises a touch user interface device in communication with a processing device. The interface device includes a sensor array for sensing spatial information of one or more regions of contact and provides finger contact information in the form of a stream of frame data.

The processing device reads frame data from the sensor array, produces modified frame data by perform thresholding and normalization operations on the frame data, detects a first region of contact corresponding to a finger touch, and produces a features vector by extracting at least one feature of the modified frame data to. The processing devise then creates a gesture trajectory in a multi-dimensional gesture space wherein, detects a specific gesture, and generates a control signal in response to the specific gesture. The multi-dimensional gesture space comprises a plurality of feature vectors, and the gesture trajectory is a sequence of transitions between regions of the multi-dimensional gesture space

Various features of the invention can be implemented singly or in combination. These features include: using a multivariate Kalman filter to overcome the presence of random signal noise to avoid jittery cursor movement when finger position controls a user interface cursor; using High performance segmentation using Connected Component Labeling with subsequent label merging employing a Hausdorff metric for the implementation of multi-touch capabilities; automating a threshold selection procedure by training an Artificial Neural Network (ANN) and measuring how various thresholds affect the miss rate; constructing a multi-dimensional gesture space using a desired set of features (not just centroid position and velocity), wherein each feature is represented by a space dimension; representing a gesture trajectory as a sequence of transitions between pre-calculated clusters in vector space (“Vector Quantization codebook”) allows model it as a Markov Process; and implementing a principle component analysis operation.

These and other features, aspects, and advantages of the present invention will become better understood with reference to the following description and claims.

BRIEF DESCRIPTIONS OF THE DRAWINGS

The above and other aspects, features and advantages of the present invention will become more apparent upon consideration of the following description of preferred embodiments taken in conjunction with the accompanying drawing figures, wherein:

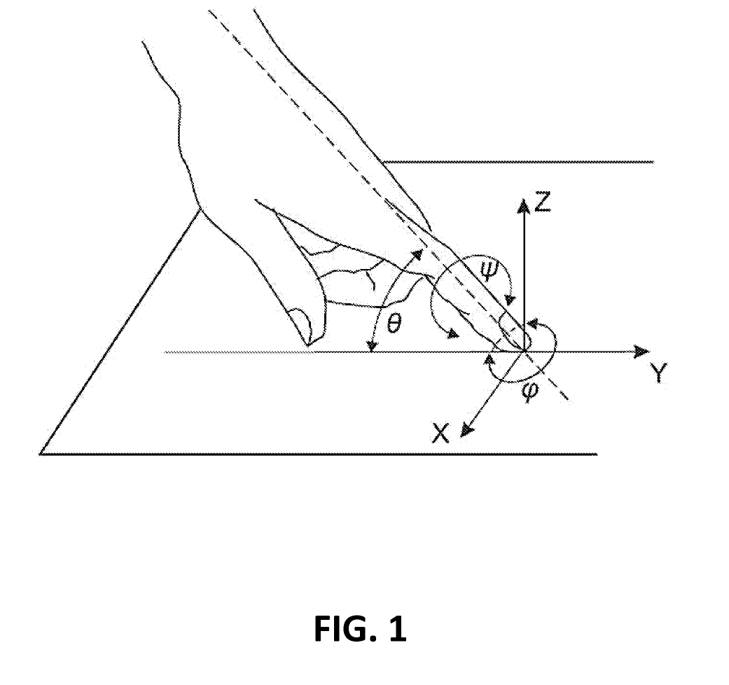

FIG. 1 depicts a 3D coordinate system with the Z-axis is defined vertically, perpendicular to X-Y plane using notation for angular features (Euler angles).

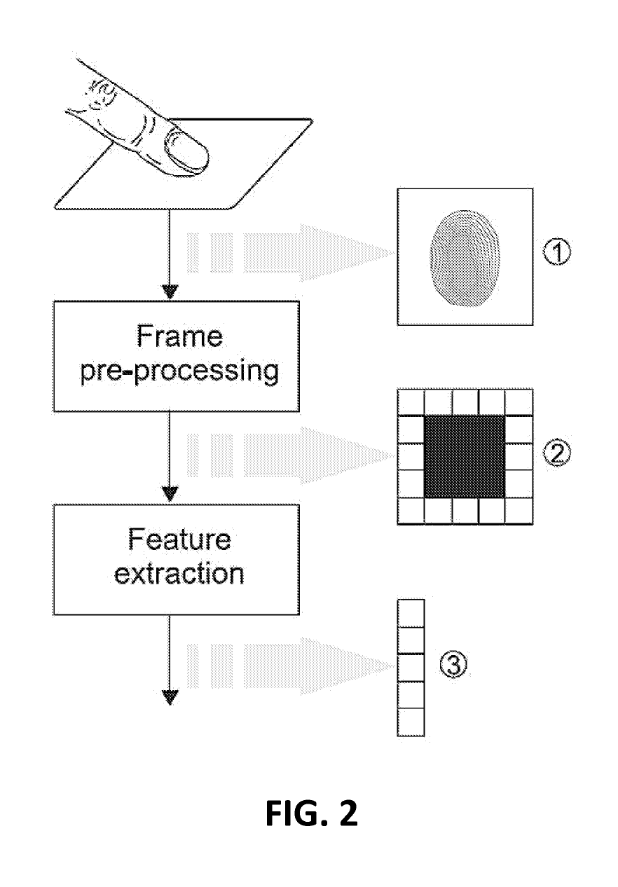

FIG. 2 depicts a process provided for by the invention wherein a frame is read from the sensor array, subjected to thresholding and normalization operations resulting in a modified version of the frame which is in turn subjected to feature extraction operations to produce a features vector.

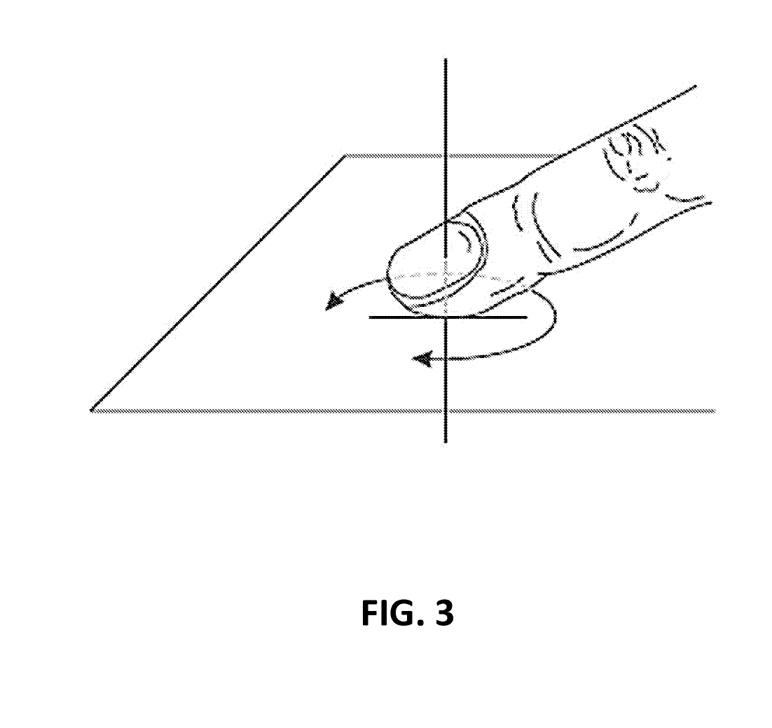

FIG. 3 depicts finger posture changes which would cause variation of estimate Euler's φ angle of the finger with respect to the touch surface.

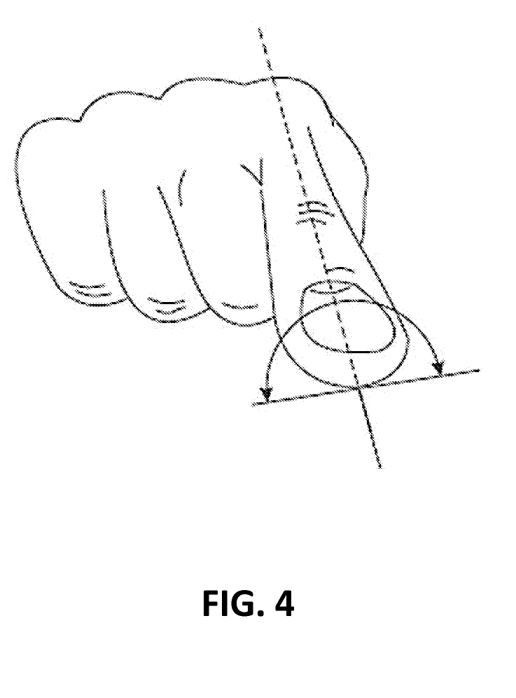

FIG. 4 depicts finger posture changes which would cause variation of estimate Euler's ψ angle of the finger with respect to the touch surface.

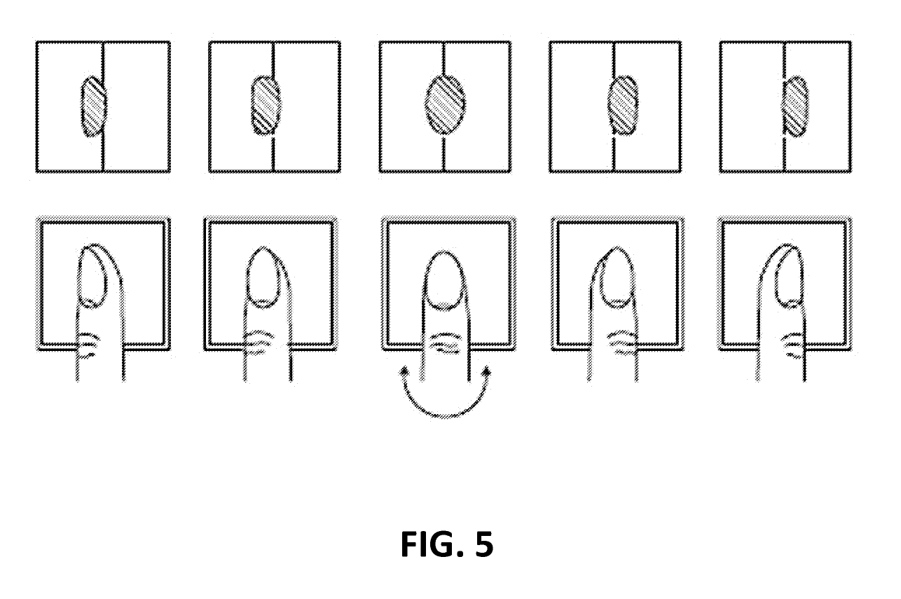

FIG. 5 illustrates how as a finger rolls on a touch surface away from a neutral position, the leading edge is usually “flatter” as compared to the trailing edge.

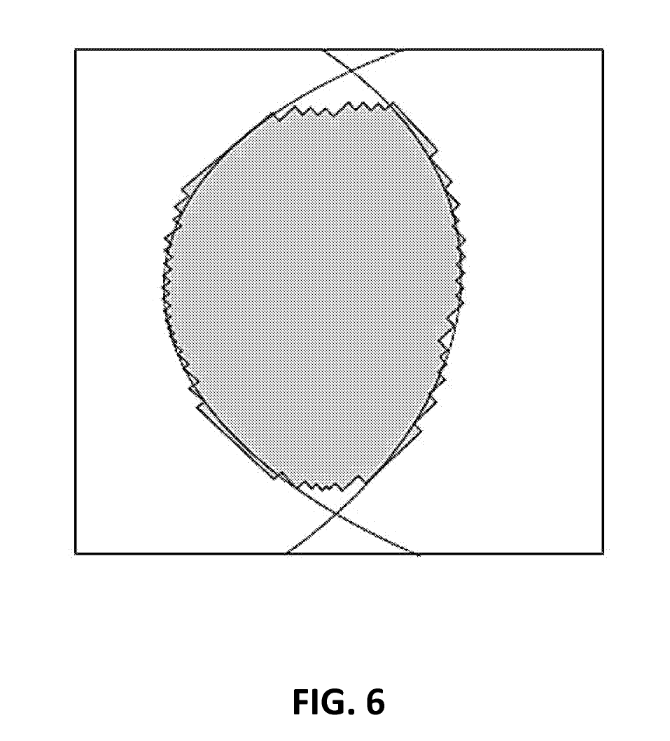

FIG. 6 depicts a representation wherein the curved shape of edges of an area of finger contact with a touch surface is approximated with second degree polynomials.

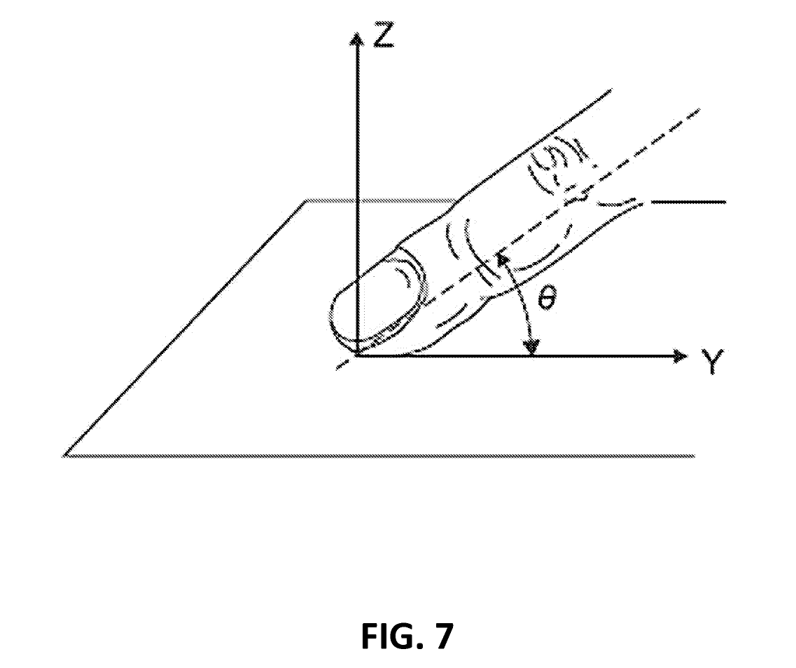

FIG. 7 depicts finger posture changes which would cause variation of estimate Euler's θ angle of the finger with respect to the touch surface.

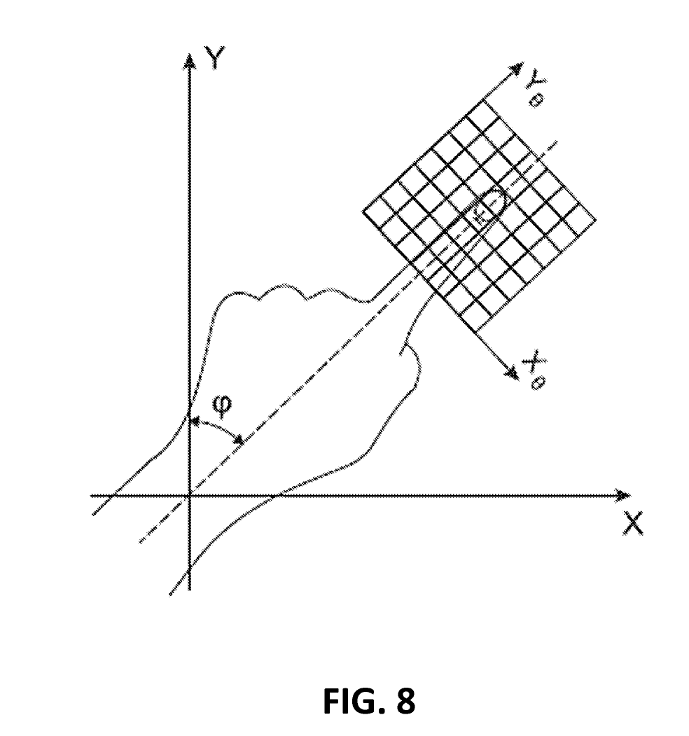

FIG. 8 illustrates the use of row and column scanning to find the left, right, top, and bottom finger edges of a finger shape measurement, wherein rows and columns are defined in a coordinate system in which projection of major axis a finger distal phalanx to X-Y plane is parallel to Y axis.

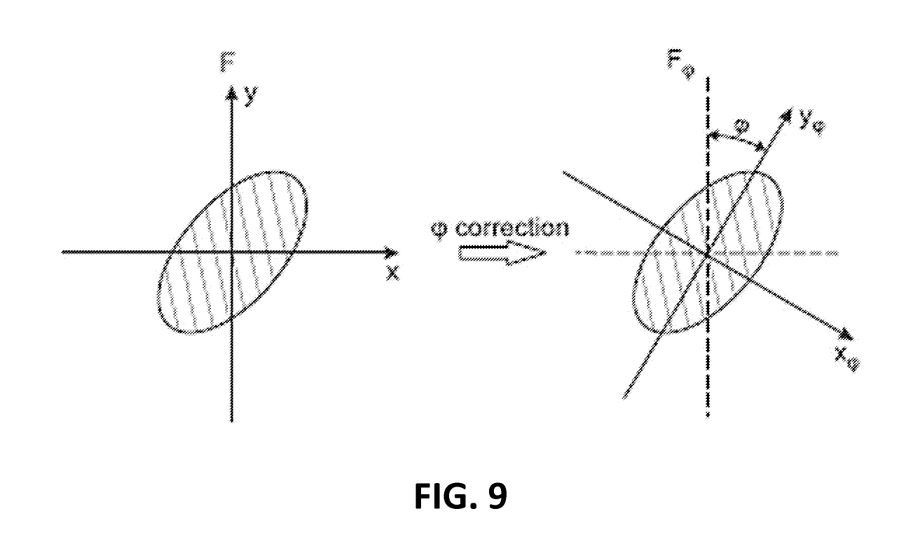

FIG. 9 shows results of a φ (yaw angle) correction as provided for by the invention.

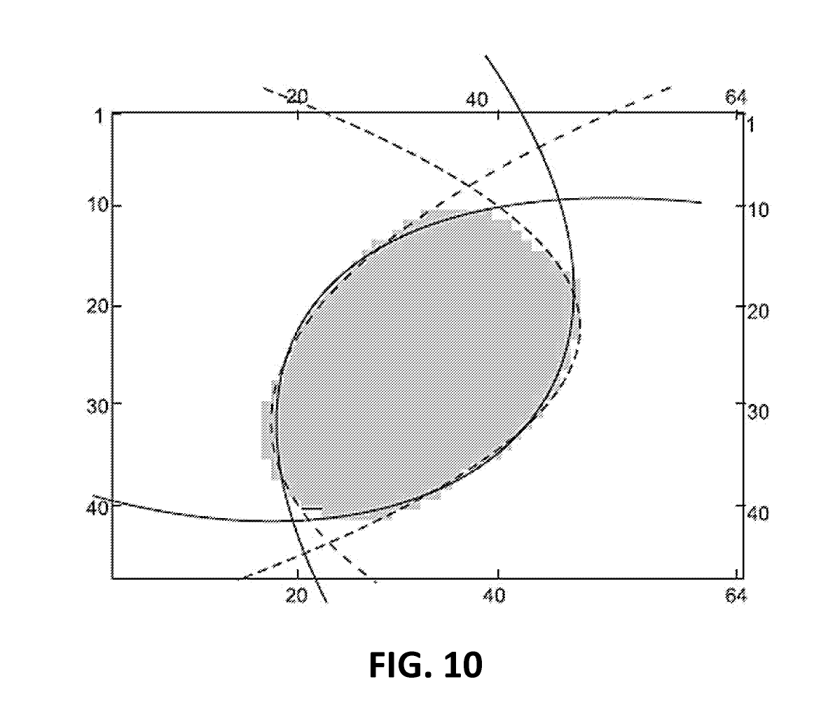

FIG. 10 shows results of φ correction on left and right edge detection operations as provided for by the invention.

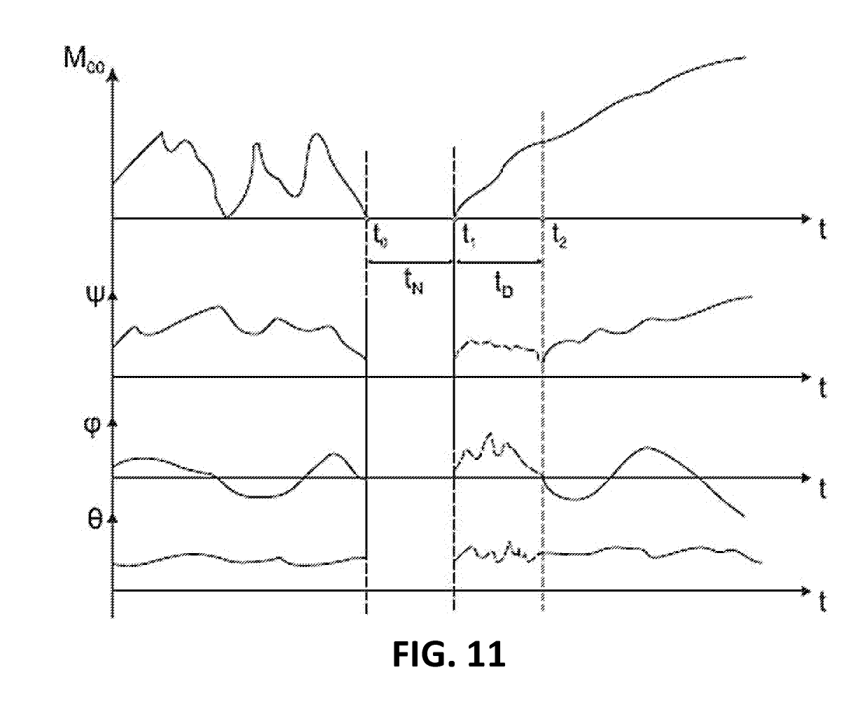

FIG. 11 depicts a representative dampening filter operation as provided for by the invention.

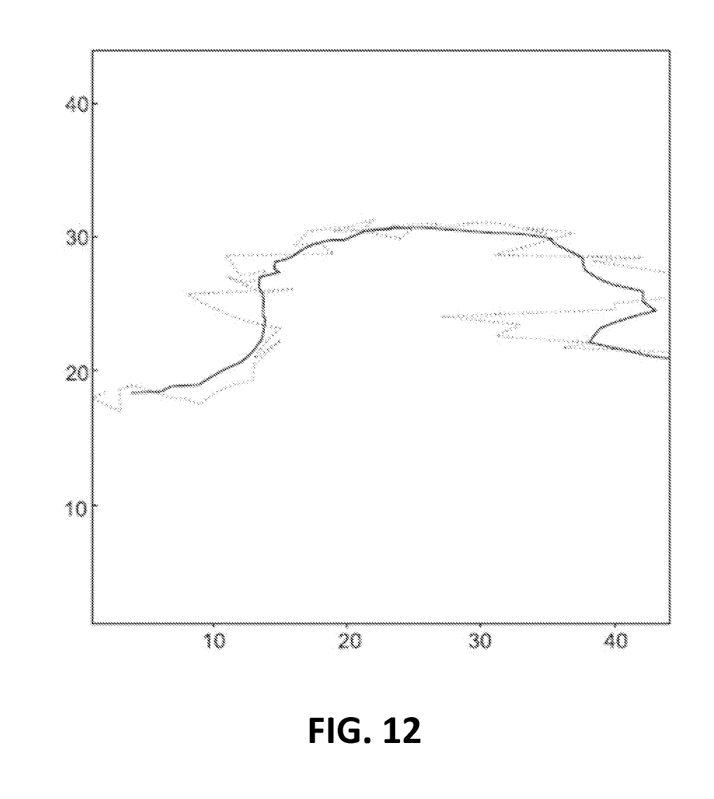

FIG. 12 shows a finger centroid trajectory on a touch surface, with the dotted line showing the original value, and the solid line a value smoothed by a Kalman filter as provided for by the invention.

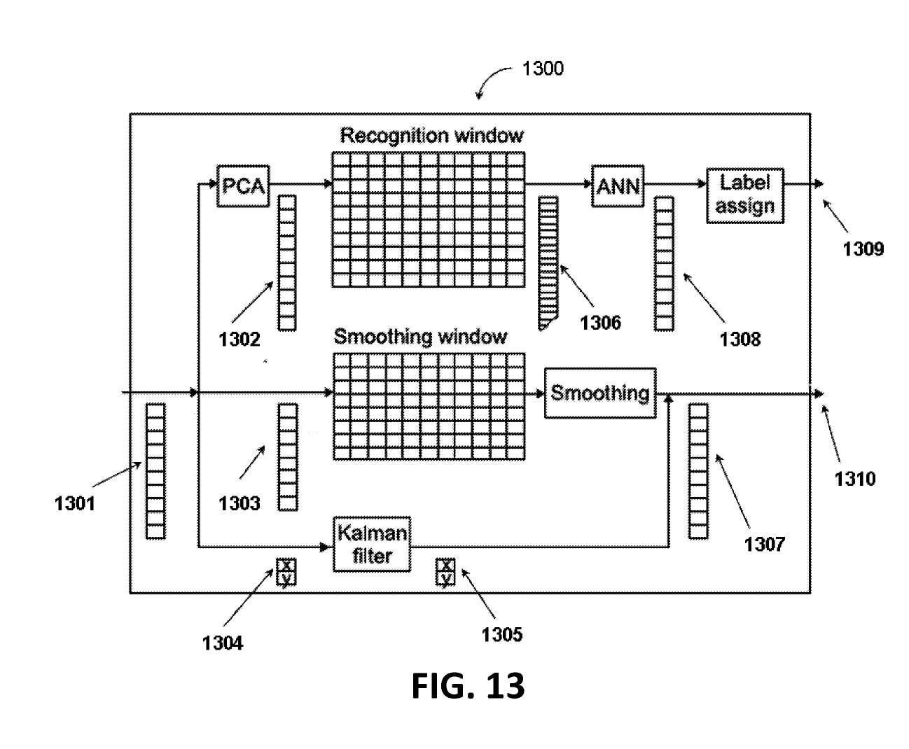

FIG. 13 depicts an architecture of a gesture recognition module as provided for by the invention.

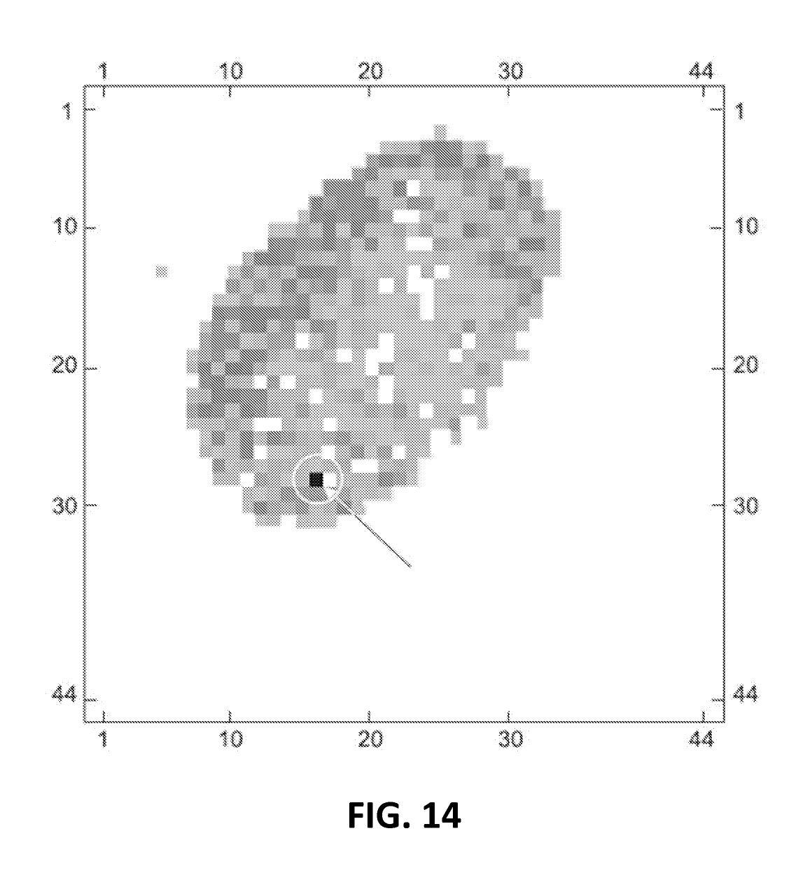

FIG. 14 depicts a frame for a sample finger application comprising defective pixels.

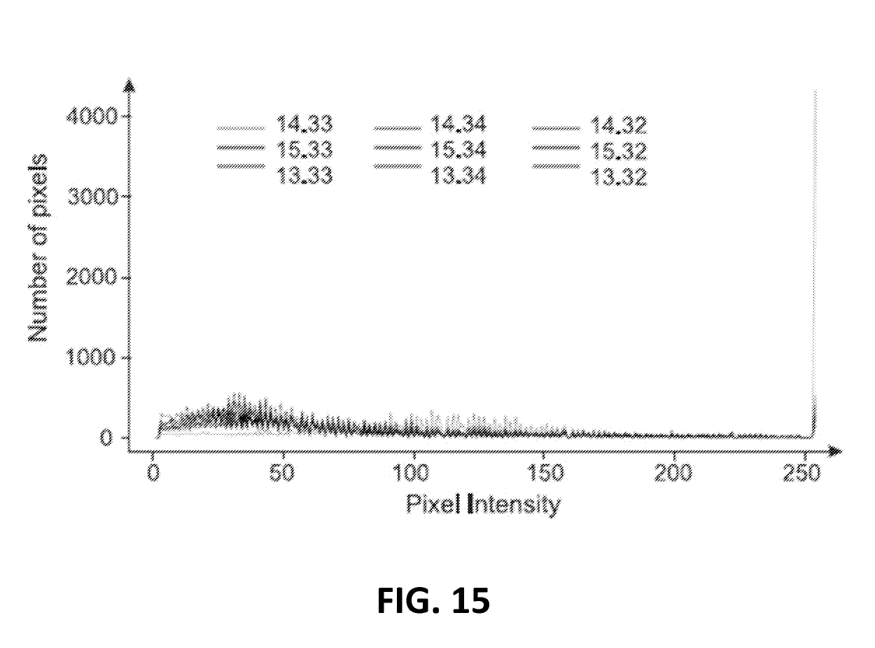

FIG. 15 depicts representative pressure distribution histograms, based on statistics collected over time for anomalous pixel with coordinates (14, 33) and its immediate neighbors.

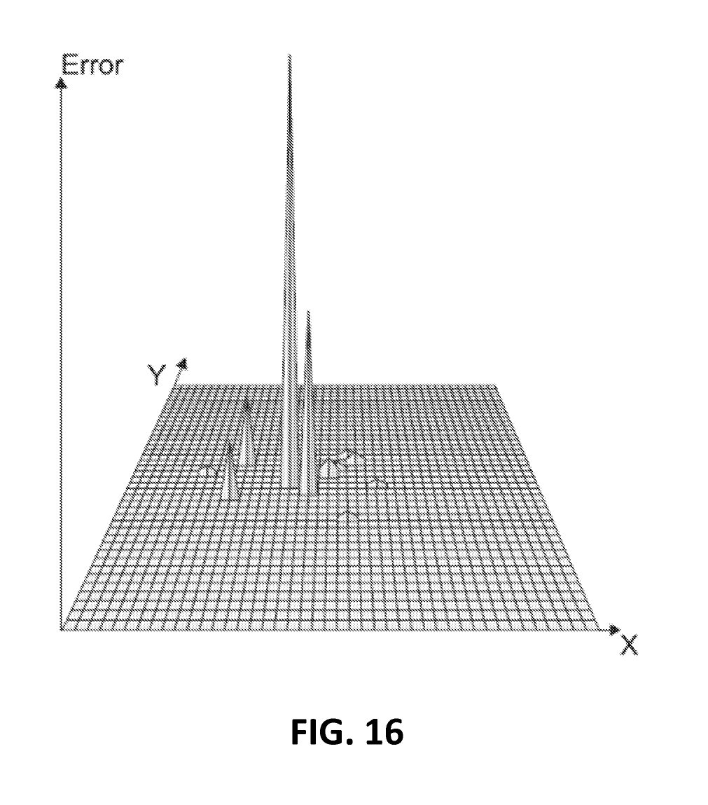

FIG. 16 depicts the Mean Squared Error between the pressure distribution histogram of every pixel and the pressure distribution histograms of its neighbors.

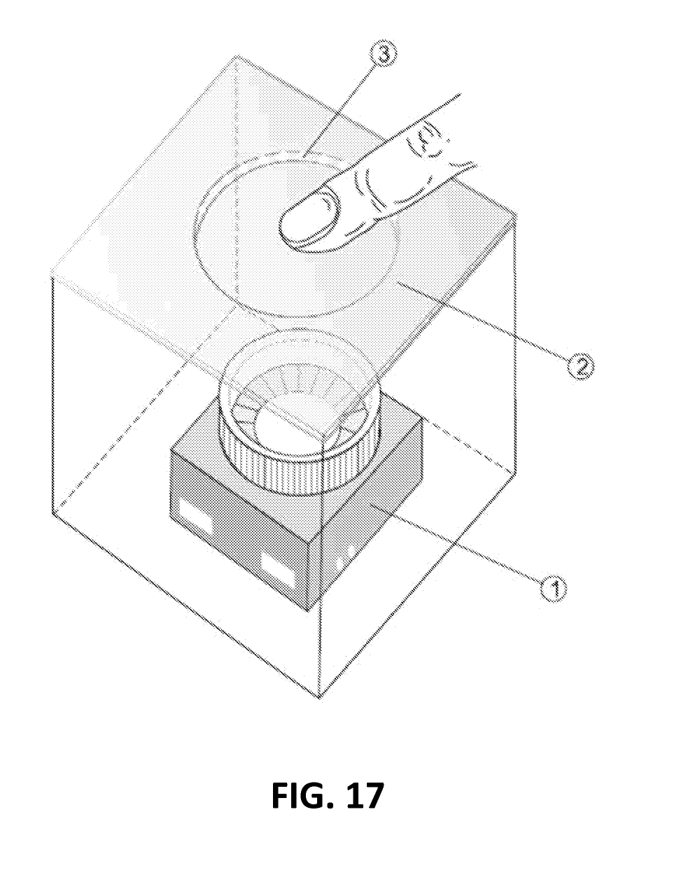

FIG. 17 depicts a camera-based optical sensor that easily and inexpensively allows acquisition of high resolution touch data and implements optical user interface sensing.

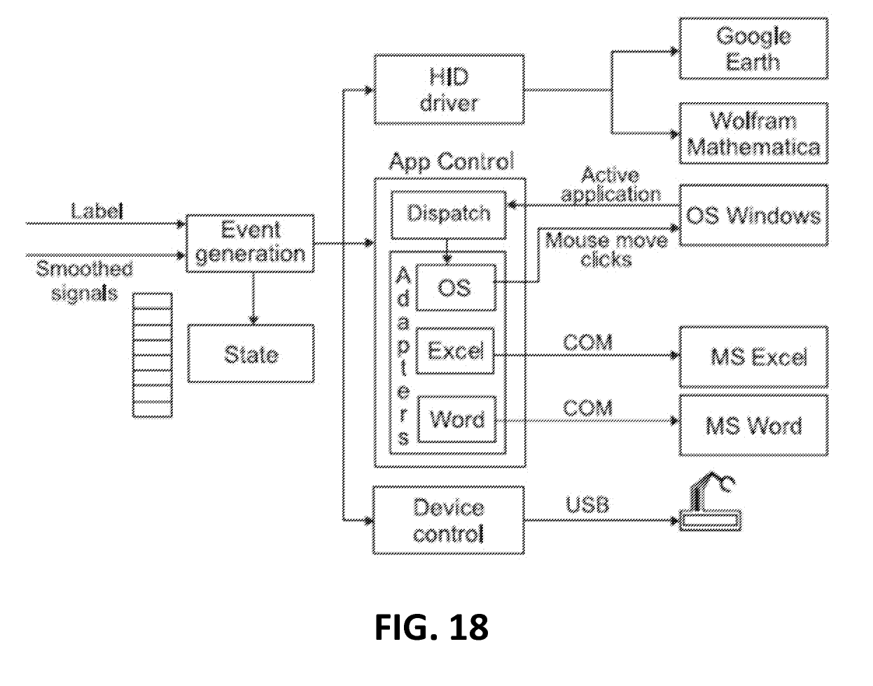

FIG. 18 depicts an architecture of an example representative control system whose inputs are gesture label and smoothed signals from a gesture recognition module such as that depicted in FIG. 13.

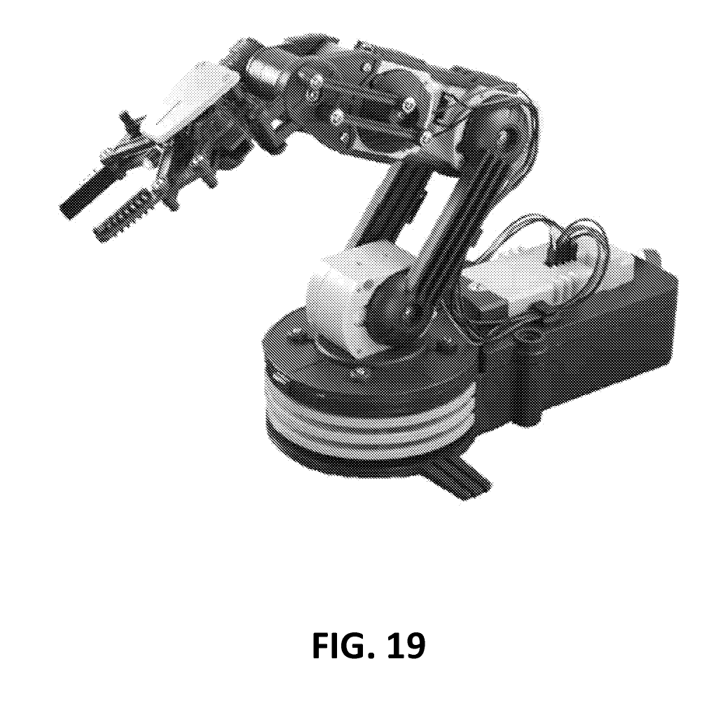

FIG. 19 depicts a representation of a OWI Robotic Arm [11]product, used in an application of the invention.

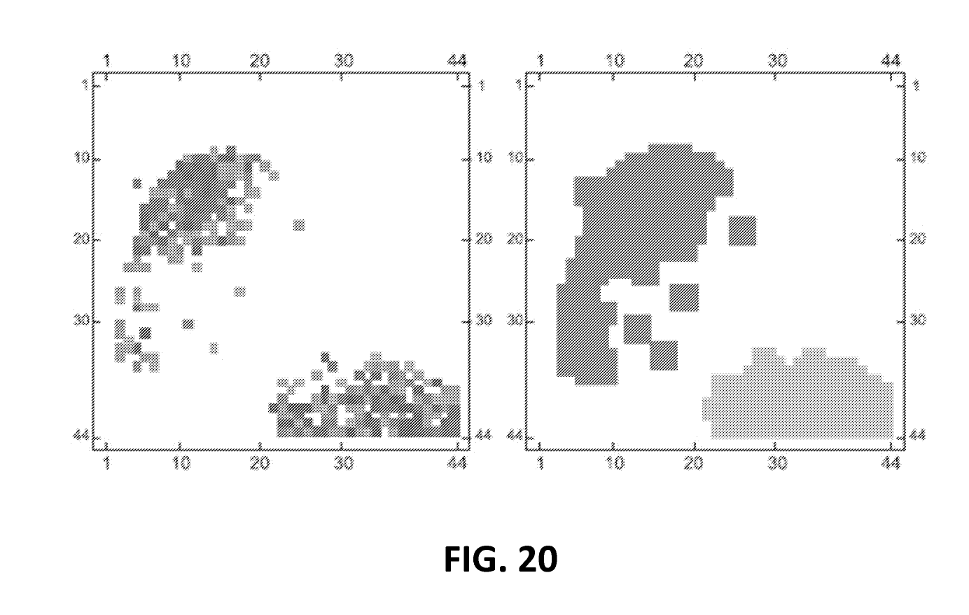

FIG. 20 depicts an example of high performance segmentation using Connected Component Labeling with subsequent label merging employing a Hausdorff metric wherein original sensor data is shown along side the two distinct finger images resulting from this operation.

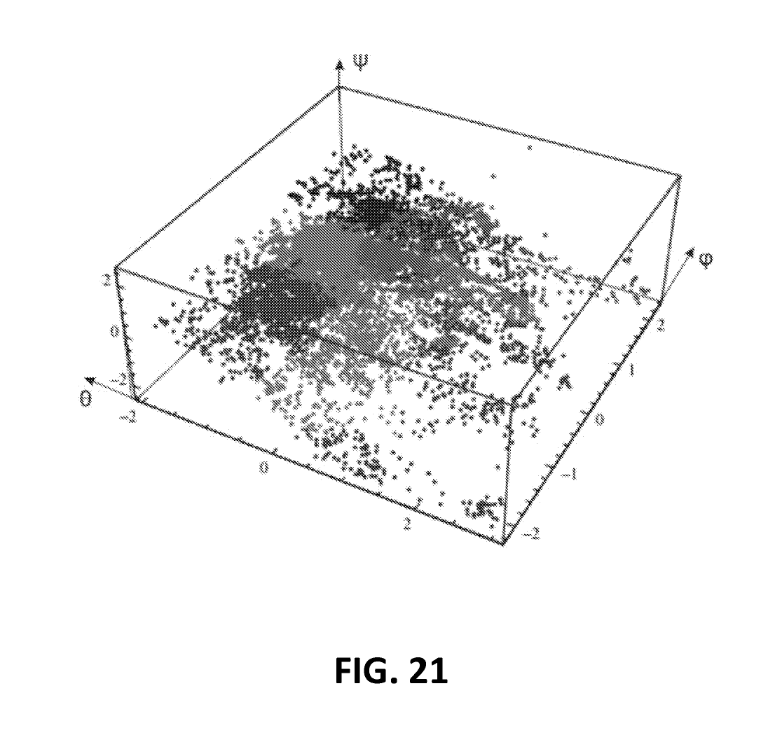

FIG. 21 depicts a three dimensional gesture space with gesture trajectory points clustered using Cosine Similarity as provided for by the invention.

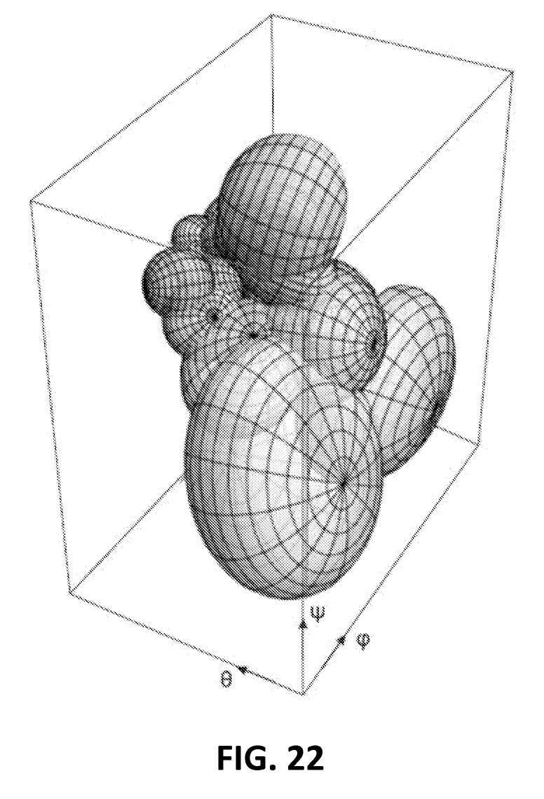

FIG. 22 depicts an alternate visualization of clusters from FIG. 21, here employing multivariate Gaussian represented as an ellipsoid based on a covariance matrix of eigensystem and using 0.95 critical value of x² (Chi-square) distribution.

### DETAILED DESCRIPTION

In the following description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention.

In the following description, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

1 Introduction

The present invention accordingly addresses gesture recognition on touch surfaces incorporating 3D finger posture detection so as to implement recognition of gestures with 3D characteristics.

1.1 Finger Posture

Consider the interaction scenario of the user performing finger gestures on a flat touch-sensitive surface. Each finger contacting the touch surface has a position and posture. To describe these, a coordinate system is introduced.

In the coordinate system used in this article, an X-Y plane is aligned atop of the touch-sensitive surface, with the Y axis aligned perpendicularly to the user. A Z-axis is defined vertically, perpendicular to X-Y plane. This is the coordinate system is illustrated in FIG. 1.

Most existing touch interfaces operate only from finger position, which represents a point of contact between finger and touch surface in X-Y plane with two-dimensional coordinates.

However, this same point of contact could correspond to different finger postures in three dimensional space. A representation of the posture could be expressed via Euler angles, commonly denoted by letters: (φ, θ, ψ). There are several conventions for expressing these angles, but in this article Z-X-Z convention is used. The Euler angles describing finger posture are shown in FIG. 1.

When designing user interaction on a touch surface it is convenient to define a comfortable and convenient finger “neutral posture;” the posture which causes least discomfort to the user during long term use and is conveniently posed to be a starting point for most common touchpad actions. Some recommendations made in ergonomic studies [8] recommend a straight wrist posture while avoiding excess finger flexion and static loading of the arm and shoulder.

2 Feature Extraction

In one implementation, the touch surface comprises a touch-sensitive sensor array. Each sensor array reading is a matrix of individual sensor's intensity values, representing pressure, brightness, proximity, etc. depending on the sensing technology used. This matrix of values at a given instant is called a frame and individual elements of this matrix are called pixels (in some literature, the term “sensels” is used). In an example arrangement, each frame first passes through a “frame pre-processing” step which includes pixel value normalization, accommodating defective sensors (see Section 4.1.1), and thresholding (see Section 4.1.2).

The next step is feature extraction: calculating a set of features (feature vector) for each frame. Each feature is described in Section 2.2.

The process above is illustrated in FIG. 2, wherein:
Step 1 represents a frame, as read from the sensor array.
Step 2 represents a thresholded and normalized version of the frame, used for feature extraction.
Step 3 represents the output from the feature extraction step—a features vector.

2.1 Image Moments

Discrete Cartesian geometric moments are commonly used in the analysis of two-dimensional images in machine vision (for example, see [5], [39], [4])

A representative example moments definition arrangement employs various notion a pixel intensity function. There are two useful kinds of pixel intensity function:
The first pixel intensity function, I_{raw}(X, y) simply returns the frame pixel's value.
The second pixel intensity function will use a step threshold function and will return zero for sensor pixel values below a specified threshold and 1 for values above it, effectively producing a binary image:

$${I}_{bin} ( x , y ) = \{ \begin{matrix}1 & {I}_{raw} ( x , y ) >= threshold \\ 0 & {I}_{raw} ( x , y ) < threshold\end{matrix} \qquad ( 1 )$$

The moment of order (p+q) for a gray scale image of size M by N with pixel intensities I_{raw} can be defined as:

$${\tilde{M}}_{p , q} = {\sum }_{x = 1}^{M} {\sum }_{y = 1}^{N} {x}^{p} {y}^{q} {I}_{raw} ( x , y ) . \qquad ( 2 )$$

A variant of this same moment, using I_{bin}, is:

$${M}_{p . q} = {\sum }_{x = 1}^{M} {\sum }_{y = 1}^{N} {x}^{p} {y}^{q} {I}_{bin} ( x , y ) \qquad ( 3 )$$

A central moment of order (p+q) for a gray scale image of size M by N with pixel intensities I_{raw} is defined as:

$${\tilde{μ}}_{p , q} = {\sum }_{x = 1}^{M} {\sum }_{y = 1}^{N} {( x - \overline{x} )}^{p} {( y - \overline{y} )}^{q} {I}_{raw} ( x , y ) \qquad ( 4 )$$

A variant of the same central moment, using I_{bin} is:

$${μ}_{p . q} = {\sum }_{x = 1}^{M} {\sum }_{y = 1}^{N} {( x - \overline{x} )}^{p} {( y - \overline{y} )}^{q} {I}_{bin} ( x , y ) \qquad ( 5 )$$

2.2 Features

In this section some representative features that can be extracted from a frame are provided.

2.2.1 Area

M_{0.0} is the number of pixels in frame with value exceeding the specified threshold. This is sometimes called area, and this term will be subsequently used to describe this feature.

The term “finger imprint” will be used to refer to a subset of frame pixels with measurement values exceeding the specified threshold—this corresponds to a region of contact by a user's finger. Note that in multi-touch operation or multi-touch usage situations there will be multiple finger imprints that can be measured from the touch sensor.

2.2.2 Average Intensity

This feature represents an average intensity of non-zero pixels in the frame:

$$\overline{i} = \frac{{\tilde{M}}_{0.0}}{{M}_{0.0}} \qquad ( 6 )$$

2.2.3 Centroids

Interpreting pixel intensity function as a surface density function allows calculation of the geometric centroid of a finger imprint.

While using I_{raw} as an intensity function gives:

$$\overline{\overline{x}} = \frac{{\tilde{M}}_{10}}{{\tilde{M}}_{00}} \\ \overline{\overline{y}} = \frac{{\tilde{M}}_{01}}{{\tilde{M}}_{00}} \qquad ( 7 )$$

while using I_{bin} as an intensity function gives:

$$\overline{x} = \frac{{M}_{10}}{{M}_{00}} \\ \overline{y} = \frac{{M}_{01}}{{M}_{00}} \qquad ( 8 )$$

Centroids can be used to estimate finger position. See Section 2.4.1 for details.

2.2.4 Eigenvalues of the Covariance Matrix

A covariance matrix of I_{bin}(x, y) is:

$$[ \begin{matrix}{μ}_{2 , 0} & {μ}_{1 , 1} \\ {μ}_{1 , 1} & {μ}_{0 , 2}\end{matrix} ] \qquad ( 9 )$$

The first and second eigenvalues of the matrix in equation 9 are:

$${λ}_{1} = \frac{{μ}_{0 , 2} + {μ}_{2 , 0} - \sqrt{{μ}_{0 , 2}^{2} + 4 {μ}_{1 , 1}^{2} - 2 {μ}_{0 , 2} {μ}_{2 , 0} + {μ}_{2 , 0}^{2}}}{2} \\ {λ}_{2} = \frac{{μ}_{0 , 2} + {μ}_{2 , 0} + \sqrt{{μ}_{0 , 2}^{2} + 4 {μ}_{1 , 1}^{2} - 2 {μ}_{0 , 2} {μ}_{2 , 0} + {μ}_{2 , 0}^{2}}}{2} \qquad ( 10 )$$

The eigenvalues λ₁ and λ₂ are proportional to the squared length of the axes of finger imprint as measured on a touch sensor. From these one can form θ₁ and θ₂ are two features representing scale-invariant normalizations of λ₁ and λ₂:

$${e}_{1} = \frac{{λ}_{1}}{{μ}_{0 , 0}} \\ {e}_{2} = \frac{{λ}_{2}}{{μ}_{0 , 0}} \qquad ( 11 )$$

2.2.5 Euler's φ Angle

A finger imprint typically has a shape of a (usually oblong) blob. The aspects of the asymmetry of this blob could be used to estimate Euler's φ angle.

Example finger posture changes which would cause variation of φ are shown in FIG. 3.

The eigenvectors of the matrix in equation 9 correspond to the major and minor axes of the finger imprint. φ can be calculated as an angle of the major axis, represented by the eigenvector associated with the largest eigenvalue [5]:

$$φ = \frac{1}{2} {tan}^{- 1} ( \frac{2 {μ}_{1 , 1}}{{μ}_{2 , 0} - {μ}_{0 , 2}} ) \qquad ( 12 )$$

An alternative formula that could be used to calculate φ is:

$$φ = \frac{1}{2} {cot}^{- 1} ( \frac{{μ}_{2 , 0} - {μ}_{0 , 2}}{2 {μ}_{1 , 1}} ) \qquad ( 13 )$$

One can use one of the above equations (12 or 13), depending on which of μ_{1,1} or μ_{2.0}−μ_{0.2} is zero, to avoid an undefined value caused by division by zero[19].

Due to anatomic limitations and ergonomic considerations, most user interactions on touch surfaces fall within a certain range of φ angles, somewhat centered around a value of φ corresponding to a neutral posture. Since equation 12 could never numerically evaluate to ±π/2 and equation 13 could never numerically evaluate to −π/2 it is convenient to choose a coordinate system in which the φ angle corresponding to a neutral posture does not fall close to nπ+π/2, n ∈ Z minimize the likelihood of their occurrence. For example, a coordinate system in which φ value for neutral posture equals 0 is a good choice.

In real-time systems, instead of equation 13 a high-performance closed-form single scan algorithm [19] could be used.

2.2.6 Euler's Angle

Example finger posture changes which would cause variation of Euler's ψ angle are shown in FIG. 4. This could be informally described as “rolling” a finger on the surface.

An accurate estimation of this angle based on finger imprint is challenging. Some approaches which could be used to estimate ψ are:
Magnitude of a projection of vector \vec{(\tilde{x̅}, \tilde{y̅}), ( x̅, y̅)} to X-axis (performed after φ correction, as described in Section 2.3);
Skewness of per-column sums of pixel intensities;
A slope, found by applying linear regression to per-column sums of pixel's intensities
Ratio of eigenvalues;
Shape-based algorithms.

The shape-based approach described below is particularly useful for optical sensors (discussed in Section 4.1.2) and capacitive tactile array sensors as these exhibit very little pixel intensity variation within the finger imprint area, limiting the effectiveness of approaches 1-4.

While the finger is in a neutral posture, the left and right edges of its imprint shape typically have roughly the same curvature. As the finger rolls, away from the neutral position the leading edge is usually “flatter” compared to the trailing edge (as shown in FIG. 5). As ψ increases, the shapes change accordingly: the leading edge becomes flatter while the trailing edge becomes more pronouncedly curved.

These changes in curvature permit the value of Euler's ψ angle to be estimated based on the difference between edge curvatures [47] using the following steps:

The first step is left and right imprint's edge detection, which is performed after initial thresholding and φ correction (described in Section 2.3). This could be done using zero-crossing on per-row intensity values, however more sophisticated algorithms such as Canny Edge Detector could also be used.

The second step is a polynomial curve fitting to the sets of points constituting the left and right edges. The row number is interpreted as abscissa and column number as an ordinate. The shape of the edges is approximated with a second degree polynomial, as shown in FIG. 6.

If for a given edge the variable r denotes row number and the variable c column number, the equation describing the edge would be:

c=α₀+a₁r+a₂r² (14)

The polynomial coefficients could be estimated using least squares:

a=(X^{t}X)⁻¹X^{T}y (15)

The signed curvature of a parabola specified by equation 14 is:

$$k = \frac{{c}^{″}}{{( 1 + {c}^{′2} )}^{\frac{3}{2}}} \qquad ( 16 )$$

Taking derivatives gives us:

$$k = \frac{2 {a}_{2}}{{( 1 + {( {a}_{1} + 2 {a}_{2} r )}^{2} )}^{\frac{3}{2}}} \qquad ( 17 )$$

A parabola curvature is greatest at vertex which is located at:

$${r}_{v} = - \frac{{a}_{1}}{2 {a}_{2}} \qquad ( 18 )$$

Thus a signed curvature at vertex point could be calculated by substituting r in Equation 17 with rᵥ from Equation 18:

kᵥ=2a₂ (19)

which is also a second derivative c″ from Equation 14. As such it will have opposite signs for parabolas fitting the left and right edges, as one of parabolas will typically concave left while other will typically concave right.

The sum of the two kv terms will change magnitudes and signs in a way that monotonically tracks the changing LP angle that is defined to be zero when parabolas are similar, negative in one direction, and positive in the opposite direction:

φ∝(leftₐ₂+rig htₐ₂) (21)

where leftₖ_{ᵥ} and rightₖ_{ᵥ} are curvature values at vertex point for parabolas fit to the left and right edges of finger imprint. Substituting kᵥ using Equation 19 gives the even simpler formula:

ψ∝(leftₖ_{ᵥ}+rig htₖ_{ᵥ}) (20)

where leftₐ₂ and rightₐ₂ are a₂ coefficients from Equation 14 from parabolas fit to left and right edges of finger imprint, found using Equation 15.

2.2.7 Euler's θ Angle

Example finger posture changes which would cause variation of Euler's θ angle are shown in FIG. 7.

A shape-based algorithm which could be used to estimate θ is described below. Row and column scans are used to find the top, bottom, left and right edges of a finger's imprint. This step is performed after initial thresholding and φ correction, described in Section 2.3. This produces vectors of x coordinates for the left and right edges: Xₗ and Xᵣ respectively and similarly y coordinates for the top and bottom edges. Taking arithmetic mean values of these vectors will give respective coordinates for the sides of a box roughly approximating the shape of the finger's imprint.

An empirical formula, shown to provide a good estimate of θ is:

$$θ ∝ \frac{\sqrt{{( \overline{{X}_{r}} - \overline{{X}_{l}} )}^{2} + {( \overline{{Y}_{t}} - \overline{{Y}_{b}} )}^{2}}}{{M}_{0 , 0}} \qquad ( 22 )$$

Geometrically this can be described as the length of a diagonal of a rectangle approximating the finger's imprint normalized by the value of the area feature. This equation incorporates several essential details; linear approximation of the edges, usage of a diagonal length, and normalization by M_{0,0} rather than width×height.

This formula has been shown experimentally to give a good correlation with finger application angle θ and could be used as an empirical estimator of such. It is also scale-invariant which is important due to anatomical size variations of finger size between individuals.

2.3 φ Correction

The shape-based algorithms for calculating ψ and θ described in Sections 2.2.6 and 2.2.7 are sensitive to Euler's angle φ of the finger's application due to the use of row and column scanning to find the left, right, top, and bottom finger edges. During these operations rows and columns are defined in a coordinate system in which projection of major axis a finger distal phalanx to X-Y plane is parallel to Y axis. This is illustrated by FIG. 8. The actual finger imprint could be rotated in X-Y plane by arbitrary φ angle.

To use shape-based algorithms discussed in Sections 2.2.6 and 2.2.7, the φ angle is calculate first, and then used to perform φ correction before calculating ψ and θ. Equation 23 shows the correction operation—a transformation of vector F containing coordinates of a frame's pixels to F_{φ} by using rotation matrix, effectively rotating them by angle φ about the origin the coordinate system.

$${F}_{φ} = [ \begin{matrix}cos φ & - sin φ \\ sin φ & cos φ\end{matrix} ] F \qquad ( 23 )$$

FIG. 9 demonstrates the results of φ correction.

It is also possible to implement another, more sophisticated algorithm, combining rotation with edge detection to minimize errors caused by the discrete nature of pixel coordinates.

The effect of φ correction on left and right edge detection is shown at FIG. 10. The dashed lines show curves, approximating uncorrected left end right edges, while the solid lines show ones calculated after φ correction. The curves in general are different, so without φ correction, incorrect ψ and θ values will be calculated using shape-based approaches described in Sections 2.2.6 and 2.2.7.

2.4 Signal Processing

A temporal sequence of feature vectors could be viewed as a set of pseudo-continuous signals. Some of these signals could be used as control inputs to control software applications or hardware (see Section 4.2) by varying finger posture and position on the touch surface.

Some signals could benefit from several optional processing steps, such as applying filters, described below.

When a human finger touches the sensor surface, it deforms. Some signals, such as Euler's angles could not be reliably calculated during this initial deformation. This could be addressed by using a dampening filter. This filter ignores frames for time td following initial finger contact with the sensor surface. To avoid filter activation due to noisy sensor readings, it is activated only if finger touch is detected after an absence for a certain minimal period of time tₙ.

FIG. 11 illustrates a representative dampening filter operation. M_{0,0} is used to detect whenever a finger is touching the surface. In the depicted example, the finger is removed from the surface at t₀ and re-applied at t₁. Since the duration of finger absence (t₁−t₀) tn the dampening filter is activated, suppressing output of unreliable calculations of φ, ψ, and θ signals t_{d}, until t₂. The dashed line shows suppressed signals values.

A signal's random noise could be attenuated by using a low-pass filter. A causal filter approach is used to estimate the value of a signal at a given point in time using locally weighted scatterplot smoothing (LOWESS)[3] model applied to ws prior values. These values are called smoothing window. Such filter is used for smoothing finger posture-related signals such as Euler's angles. Smoothing of finger position signals is discussed in Section 2.4.1.

2.4.1 Estimating Finger Position

A touchpad or touchscreen are examples of a common use of touch surface where the user controls applications by changing the position of their finger on the surface. In software applications, the position of the finger is expressed as 2D coordinates in X-Y plane. A finger position estimation problem is calculating such 2D coordinates representing finger position in a frame.

As mentioned in Section 2.2.3, centroids can be used to estimate finger position. An argument for choosing between (cy, cy) and ( x̅, y̅) for different types of sensors is provided in Section 4.1.

Regardless of which centroid is used, the presence of random signal noise could cause jittery cursor movement when finger position is used to control the cursor. For centroid signals, a multivariate Kalman filter [10] is used as its empirical performance is better than that of a local linear regression for this application. FIG. 12 shows a representative finger centroid trajectory on a touch surface, with the dotted line showing the original value, and the solid line a value smoothed by the Kalman filter.

One of the effects of smoothing with a causal filter is that after the finger has been removed from the sensor while there are at least 2 previous signal values in the smoothing window, it would continue to estimate “phantom” values of those signals. For example, at a rate of 100 frames per second with a 30 frame smoothing window size, the causal LOWESS smoothing filter will produce signal values for 280 ms after the finger has been removed. This effect could noticeable to the user. To avoid this, an instant cut-off feature is introduced. It prevents the use of the LOWESS smoother if finger presence is not detected in the current frame (the area signal is 0).

3 Gesture Recognition

Extracted temporal sequence of feature vectors could be used to recognize a set of predefined gestures, performed by changing finger posture and position on a touch surface. The gesture recognition module processes a stream of feature vectors (in real time) and attempts to recognize a gesture presence and boundaries.

A user can perform a variety of gestures. The most basic gestures involve the variation of only a single parameter of finger posture or position. The initial set of such basic gestures could be:
Sway User changes x coordinate of finger position (swiping the finger left to right or right to left).
Surge User changes y coordinate of finger position (swiping the finger towards or away from the body).
Heave User changes ī (varying the pressure, applied by the finger to the touchpad).
Yaw User changes φ, varying corresponding angle, as shown on FIG. 3.
Roll User changes ψ, varying corresponding angle, as shown on FIG. 4.
Pitch User changes θ signal, varying corresponding angle, as shown on FIG. 7.

The feasibility of recognition of posture-independent gestures such as surge, sway and to a small extend heave (i.e. finger taps) has been proven and recognition of such gestures have been incorporated into existing products such as Apple MacOS. However recognition of gestures involving variations of 3D finger posture such as yaw, roll and pitch remains relatively unstudied at the time of writing this article with exception of work by NRI [29, 19, 25, 47, 46, 38, 37].

A gesture recognition problem could be viewed as a pattern recognition problem sometimes referred to as sequence labeling [32], and commonly studied in the field of speech recognition. It has been formulated as:

“In sequence labeling problems, the output is a sequence of labels y=(y′, . . . y^{T}) which corresponds to an observation sequence x=(x′, . . . , x^{T}). If each individual label can take value from set Σ, then the structured output problem can be considered as a multiclass classification problem with |Σ|^{T} different classes.”

Representing each gesture as two directional labels produces the following initial set of gesture labels Σ₀:

$${\sum }_{0} = \{ {yaw}_{left} , {yaw}_{right} , {roll}_{left} , {roll}_{right} , {pitch}_{left} , {pitch}_{right} \} \qquad ( 24 )$$

To represent a situation where no gesture is present, an additional null label, denoted by symbol □ is introduced, producing the final set of labels Σ:

Σ={Σ₀,□} (25)

Each frame (at time t) could be represented by a feature vector, for example:

$${s}_{t} = \{ {M}_{0 , 0} , \overline{i} , \overline{x} , \overline{y} , \overline{\overline{x}} , \overline{\overline{y}} , {e}_{1} , {e}_{2} , φ , θ , ψ \} \qquad ( 26 )$$

A sliding window approach to real-time sequence labeling is used, where the classification of a sample at time t is made based on w_{d} current and previous samples (sₜ, sₜ−1, . . . , sₜ−(w_{d}−1)). The value w_{d} is called gesture recognition window size. This window size is selected experimentally, based on several factors such as sampling rate and average gesture duration.

The input of the classifier at time t is the concatenation of w_{d} most recent feature vectors:

xₜ=(sₜ, sₜ₋₁, . . . , s_{t-(w}_{_{d}}₋₁₎) (27)

The output of the classifier a label from the set Σ.

3.1 Artificial Neural Network Classifier

Although other approaches could be employed, some of which are discussed in Section 5, in this section the example of an Artificial Neural Network (ANN) classifier will be used to assign the labels. Alternate classifier implementations are possible (for example [34]) and these are provided for by the invention.

In general the classifier will have |xₜ| inputs and |Σ₀| outputs. The input of the classifier is vector xₜ (see equation 24).

Based on this vector of label probabilities, a single label is selected by applying accept and reject thresholds: the label with maximal threshold is chosen if its probability is above the acceptance threshold and all other label probabilities are below the rejection threshold. This classification approach is sometimes called “one-of-n with confidence thresholds”[40]. If no label passes the threshold test the null label (□) is assigned.

In an example implementation a simple feed-forward ANN with two hidden layers using the tanh activation function is used. The ANN output layer uses the logistic activation function, so as to produce outputs in [0, 1] interval, convenient for probabilistic interpretation. For training, a variation [9] of the Rprop learning algorithm is used.

Under certain conditions some features could not be calculated. In this case the invention provides for some implementations to employ a special NULL symbol, indicating a missing value in place of the feature value in the feature vector. An ANN could not handle such input values, and they have to be handled outside of ANN classification logic. Two “missing value” cases could be distinguished and separately handled:

1. If within a given window a feature is NULL for all frames; do not send these windows to the ANN classifier and assume that no gesture is present, assigning null label.

2. If within a given window for a feature some values are NULL; try to interpolate those missing values by replacing them with the mean value for the respective feature across the window.

3.2 Principal Component Analysis

All the features discussed in Section 2.2 correspond to geometric features of the finger's 3D posture and 2D position such as Euler's angles, finger position, etc. However, higher order moments can also be used as abstract quantities in gesture recognition. Since it is difficult to predict a. priory the usefulness of different features in classification decisions, one approach is to feed as much information as possible to an ANN classifier and let it decode (brute force approach). Unfortunately, it has been shown that increasing ANN inputs above a certain number can actually cause a degradation of the performance of the ANN classifier [1]. Also, such an increase has a noticeable impact on training time and required CPU resources. The number of ANN cells and required amount of training data grows exponentially with dimensionality of the input space [1]. This is a manifestation of an effect that is sometimes referred to as “the curse of dimensionality.”

To address this problem, one can employ a dimensionality reduction technique such as a Principal Component Analysis (PCA). PCA can be defined as “an orthogonal projection of the data into a lower-dimensional linear space, known as principal subspace, such that the variance of the projected data is minimized.” [2]

A PCA operation is applied to an extended feature vector which, in addition to those features defined in sₜ (see equation 26), include additional abstract moments. An example feature vector that can be used as PCA input is:

$${s}_{pca} = \{ \overline{i} , \overline{x} , \overline{y} , \overline{\overline{x}} , \overline{\overline{y}} , {M}_{0 , 0} , {M}_{0 , 1} , {M}_{1 , 0} , {\tilde{M}}_{0 , 0} , {\tilde{M}}_{0 , 1} , \\ {\tilde{M}}_{1 , 0} , {\tilde{μ}}_{1 , 1} , {\tilde{μ}}_{2 , 0} , {\tilde{μ}}_{0 , 2} , {\tilde{μ}}_{2 , 1} , {\tilde{μ}}_{1 , 2} , {\tilde{μ}}_{2 , 2} , {e}_{1} , {e}_{2} , φ , θ , ψ \} \qquad ( 28 )$$

Each feature in the feature vector is scaled to have unit variance and shifter so as to be mean centered. The PCA operation comprises a linear transformation which, when applied to S_{pca}, produces a list of i, each corresponding to dimension in a new space. Components are ordered by decreasing variance. Some of the components which have standard deviations significantly lower than the first component could be omitted from the input provided to the ANN. It is noted that a manually set variance threshold can be used. Alternatively, a threshold selection procedure could be automated by training the ANN and measuring how various thresholds affect the miss rate.

Assuming that the original data has N intrinsic degrees of freedom, represented by M features with M>N, and some of the original features are linear combinations of others, the PCA will allow a decrease in the number of dimensions by orthogonally projecting original data points to a new, lower-dimension space while minimizing an error caused by dimensionality decrease.

The PCA parameters and transformation are calculated offline prior to use, based on a sample dataset of feature vectors calculated from representative sequence of pre-recorded frames. The parameters consist of: a vector of scaling factors pₛ (to scale values to have unit variance), a vector of offsets pₒ (to shift values to be mean centered) and transformation matrix Pₜ.

During ANN training and ANN-based gesture recognition, these three parameters are used to convert the feature vector S_{pca} into a vector of principal components cₜ:

cₜ⊂((s_{pca}−pₒ)pₛ)pₜ (29)

An ANN classifier is used as described in Section 3.1, but instead of xₜ, a vector rₜ (see Equation 30) is used as input:

rₜ=(cₜ, cₜ₋₁, . . . , cₜ−(w_{d}−0) (30)

3.3 Gesture Recognition Module Architecture

An example architecture for a gesture recognition module 1300 [48] is shown in FIG. 13. The input of the module 1301 is a vector of features Spca, which is the output of the feature extraction module, shown on FIG. 2. A PCA transformation is applied to this vector, resulting in cₜ 1302. A last wd values 1303 of cₜ are accumulated in a recognition window. The content of this window is then concatenated into a long vector rt 1306 which is submitted as input of ANN. The output of ANN 1308 is a vector of label probabilities. It is interpreted by the label assigning module, which decides what label to assign to the current frame. The assigned label 1309 is one of the outputs of the gesture recognition module.

Parallel to the “label” data flow depicted in the upper portion of FIG. 13, the same features represented by the input vector s_{pca} 1301 can also be used to obtain smoothed signals responsive representing parameters of finger position and posture. A subset sₜ of values from input vector s_{pca} 1301 is split into two vectors: vector of spatial coordinates of the centroid 1304 and the vector of remaining features from sₜ. The centroid is smoothed using the Kalman filter, resulting in a vector of smoothed centroid coordinates 1305. Other features are smoothed using LOWESS based on ws last feature vectors, accumulated in the smoothing window. These smoothed signals are concatenated back with the vector of smoothed centroid coordinates 1305 to produce a vector 1307 which contains a smoothed version of sₜ. This vector is also an output of this module 1310.

4 Example Implementations

As an example of ANN Classifier training, one can record a dataset of frames from a touch-sensitive array collected while users perform various gestures. Labeling descriptions can be manually or automatically transcribed for each frame recording an expected gesture label. Using established cross-validation techniques, the dataset can additionally be partitioned into training and validation sets. The first can be used for training ANN classifier and the second can be used to measure the performance of trained ANN classifier.

Such a classifier can be implemented, for example, in C++ using FANN [33] library. The performance of a trained ANN classifier can be sufficient to perform gesture recognition in real-time on a regular consumer-level PC at a tactile sensor frame capture rate of 100 FPS.

A gesture recognition with a miss rate below 1 percent as measured on validation data set can be readily be obtained.

4.1 Tactile Sensing Hardware

There are a variety of types of tactile sensors, for example pressure-based, capacitive and optical. In various embodiments, each has individual advantages and challenges.

4.1.1 Pressure Sensor

An example pressure sensor array, for example as manufactured by Tekscan, comprises an array of 44-by-44 presurre-sensing “pixels,” each able to report 256 pressure gradations. Although the maximum supported frame sampling rate can be 100 FPS, it can be shown that the algorithms presented as part of the invention work at rates as low as 50 FPS without significant loss of performance. This is important as lower frame rates require less CPU resources.

A finger position on this sensor could be estimated by ( \overline{\tilde{x}}, \tilde{y̅}). However due to the slightly asymmetrical shape of the finger, ( x̅, y̅) are shown to better represent the perceived contact point of the finger.

This particular senor posed several challenges: measurements can be noisy, and the sensor can have defective pixels. Moderate levels of noise does not prove to be a significant problem as the algorithms described are tolerant to a small amount of random errors in input data.

The problem with defective pixels can be much more significant. FIG. 14 shows an example of the frame for a sample finger application. In this example, one of the pixels (marked with an arrow) consistently provides a pressure value significantly higher than neighboring pixels.

During normal touch-sensitive surface use, different pixels are loaded at different times with different pressures. Over time statistics can be collected for each pixel, on distribution of discrete pressure values reported by this particular pixel during an observation period. Such a statistic can be represented as a histogram of pixel value distribution for a given pixel over time.

For a perfectly calibrated sensor array without defective pixels such a histogram should be very similar for all pixels, given the same pressure application patterns. However, under typical use applications patterns differ depending on pixel location within an array. Because of that, histograms for pixels located in different parts of the touchpad will differ. However, sufficiently nearby pixels should have similar histograms. This assumption allows the detection of anomalous pixels as those which have histograms which are significantly different from their neighbors. FIG. 15 shows pressure distribution histograms based on statistics collected over time for an anomalous pixel with coordinates (14, 33) and its immediate neighbors, and also shows the pressure value distributions for the anomalous pixel and for its immediate neighbors.

Accumulating statistics of value distribution for each pixel over time and comparing each pixel to its neighbors allows identification of pixel outliers (for example using Chauvenet's criterion).

FIG. 16 shows for every pixel a Mean Squared Error between its own pressure distribution histogram and the pressure distribution histograms of its neighbors. The measurements provided for several pixels behave significantly different and these pixels are considered anomalous.

Once identified, such defective pixels could be dealt with in different ways. In an embodiment, these can be treated in calculations as missing values, effectively ignoring them. Another approach is to estimate or interpolate correct their values based on accumulated statistics or other information.

Statistical data used in this algorithm could be collected during normal sensor usage. This permits the detection of anomalous pixels and accommodates for their presence in a manner completely transparent to the user.

4.1.2 High Resolution Optical Touch Sensor

FIG. 17 depicts a camera-based optical sensor. Although in some implementations such an arrangement can be somewhat physically large, this arrangement easily and inexpensively allows acquisition of high resolution touch data and implements optical user interface sensing. In is noted that NRI has developed technology making use of the light sensing properties of OLED (Organic Light Emitting Diode) displays and OLED transparent overlays as a high resolution optical sensing touch screen [23].

The camera-based optical sensor can, for example, comprise an upwards-facing video camera directed to view the underside of a transparent touch surface that may be fitted with an aperture bezel, and a circular light source. Such an arrangement can be adjusted so as to minimize internal reflections and the effects of ambient light. In an example implementation, considerable degrees of down-sampling can be employed. For example, a camera capable of capturing 8-bit greyscale images with 640×480 pixels resolution can be readily down-sampled to create a lower resolution (for example 64×48). In an example implementation, an adaptation of a simple box filter can be used to implement such down-sampling operations, as can other arrangements such as image signal decimation

Although an internal sensor's circular light ideally provide provides even lighting from all directions, variations can still be expected. Additionally ambient light could reflect from the user's finger, causing the finger to be unevenly lighted.

In order to compensate for uneven lighting, ( x̅, y̅) can be used instead of (\tilde{x̅}, \tilde{y̅}) to represent finger position. Further, shape-based algorithms used for ψ and θ calculation demonstrate strong tolerance to uneven lighting conditions.

The area of the finger touching the sensor has a near-homogenous luminance profile with very minor variation across pixels. This is different from pressure-based sensors where noticeable pressure variation is measured within the finger contact area.

Because an optical sensor has a depth of field in addition to part of finger touching the surface, such a sensor is capable of registering a part of the finger not in physical contact with the surface. Not surprisingly, it can be experimentally confirmed that a large depth of field introduces a large amount of irrelevant information: for example, it could register other fingers or parts of the palm.

Unlike a pressure sensor, the optical sensor requires an additional segmentation step to separate finger imprint from the background. This could be accomplished employing a simple thresholding operation. All pixels with values above this threshold belong to finger imprint while remaining ones are considered to be part of background and are suppressed by setting their value to zero.

The optimal threshold value can depend upon ambient lighting conditions. Accordingly, a simple calibration procedure to find a threshold value wherein prior to each usage session, or whenever ambient lighting conditions change, the user is asked to put a finger on the sensor and a calibration frame is recorded.

Otsu's method [36] can then be used to find a threshold value based on this calibration frame. This method finds the optimal threshold value by minimizing intra-class variance between two classes: the finger imprint and the background. This threshold value is then used in threshold filter during the frame pre-processing step.

4.2 Example Applications

As an example of a rich gesture human interface, of the 3D gestures described above can be used to control: office applications (Microsoft Word, Excel), 3D applications (Google Earth, games), scientific applications (Wolfram Mathematica) and robotics applications (a robot arm). These and a large number of other applications have been explored by NRI [12-17, 20, 22, 24, 26, 28 ].

The architecture of an example representative control system is shown in FIG. 18. The inputs of this subsystem are gesture label and smoothed signals from a gesture recognition module such as that depicted in FIG. 13.

These inputs are processed by an event generation module which converts them to events, used to control applications. Specialized applications naturally accepting 3D inputs, (such as Google Earth, Wolfram Mathematica, video games, etc.) can readily be controlled for example employing a USB (Universal Serial Bus) HID (Human Interface Device) arrangement. This can accomplished via an OS-level driver which presents a gesture controller as a USB HID [30] peripheral, which such applications are capable of recognizing and using as input controls.

To control more standard office applications, which only naturally are configured to respond to mouse and keyboard commands, an application control (“App Control”) module can be implemented. Such a module can, for example, detects what application is currently active (in the foreground of a windowing system) and, if support arrangements are available, controls that application via a custom “adapter”. Such custom adapters (for interfaceing with Microsoft Office applications, for example) map gesture events to user interface actions such as resizing spreadsheet cells or changing document fonts using COM interface. The mapping is configurable via simple user interface.

The final example application presented here is the control of a robot arm. A OWI Robotic Arm [11], is shown in FIG. 19, although a similar older model (OWI Robotic Arm Trainer) provides a wrist rotation capability. Each type of robot arm provided a different set of control metaphor opportunities.

For each application setting, 3D gesture events are mapped to the movement of joints in the robotic arm, controlled via USB protocol [45]. The mapping of gestures to joints is configurable, but the general idea is that once one of yaw, roll, or pitch gestures is detected, a metaphorically-associated joint is moved proportionally to the change of appropriate signal (φ, ψ, or θ). To provide simple operation during demonstrations, other signals are suppressed and only one joint is moving at a time.

5 Additional Features Provided for by the Invention

There are several additional features provided for by the invention. These can be grouped into three categories, each briefly described below:

5.1 Feature Extraction and Gesture Recognition Improvements

The first category is related to further feature extraction and gesture recognition performance enhancements. For example, the algorithms described above and elsewhere could be extended to work with frames sampled at a variable rate. Empirical formulae currently used for θ and ψ detailed calculation could be further refined, based on geometric properties and finger deformation models. An ANN Classifier could use more advanced neural network types and topologies. Other classifier improvements could include use of Ensemble learning and Segmental Conditional Random Fields [35].

Various methods can be used to improve the decoupling and isolation of 3D finger parameters. These include nonlinear techniques [29], piecewise linear techniques [21], and suppression/segmentation techniques [48, 46].

Extending to include multi-touch (detecting more than one finger or other parts of the hand, such as the palm or thumb) allows for the construction of more complex gestures. For example, a gesture can be defined based on change over time of finger posture parameters extracted independently and simultaneously for each finger in contact with the touchpad.

High performance segmentation using Connected Component Labeling with subsequent label merging employing a Hausdorff metric can provide good results. FIG. 20 shows original sensor data and the resulting two distinct finger images separated from it using this operation.

5.2 Hidden Markov Models

It has been previously suggested that Hidden Markov models could be used for gesture recognition [44]. One current approach provided for by the invention is an adaptation of one described in [41], but employing several, significant modifications:

An important difference is the construction of a multi-dimensional gesture space using the desired set of features, not just centroid position and velocity. Each feature is represented by a space dimension. This approach provides several advantages:
By treating feature vectors as coordinates in gesture space, each gesture could be viewed as a trajectory in this space.
Furthermore, given sample gesture data, procedures can be used to partition the gesture space into a plurality of clusters. This could be done, for example, using a clustering algorithm such as K-means.

An example of a three dimensional gesture space with gesture trajectory points clustered using Cosine Similarity is shown in FIG. 21. Each gray-scale shade represents a distinct assigned cluster grouping. An alternative visualization of the same clusters using multivariate Gaussian represented as an ellipsoid based on a covariance matrix of eigensystem and using 0.95 critical value of x² (Chi-square) distribution is shown at FIG. 22.

Representing gesture trajectory as a sequence of transitions between pre-calculated clusters (effectively a “VQ codebook”) allows modeling as a w_{d}^{th} order Markov Process (where Wd is the gesture recognition window size). A set of HMMs is trained per gesture using Baum-Welch procedure [43]. A Viterbi algorithm [6] is used to recognize a gesture, matching the current observation sequence of state transitions to a set of trained HMMs and in each finding a matching state sequence with the highest probability.

5.3 Gesture Grammars

Current touch-based user interfaces are clearly evolving in the direction of more complex gestures, richer metaphors and user interfaces specifically tailored for gesture-only interaction. Examples of very early movement in this direction can be ascribed to recent products from both Apple (Apple Touchpad, iPhone and iPad UI, and Apple Mighty Mouse) and Microsoft (Microsoft Surface, Microsoft Touch Mouse, and Microsoft Touch Pack for Windows 7). However these offerings are extremely limited.

In particular, as gesture-based human-computer interactions become more intricate with “gesture dictionaries” already containing dozens of gestures, one can see an emerging need for “gesture grammars”. Such grammars will provide a formal framework for defining and classifying as well as verifying and recognizing a variety of gestures and gesture sequences. General-purpose as well as domain-specific languages could be constructed and described using such grammars. The development of gesture grammars is an interdisciplinary study involving linguistics, human-computer interaction, machine vision, and computer science, as is seen in NRI's earlier patent applications in relating to tactile and more general gesture grammars [22, 25, 29, 31].

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Although exemplary embodiments have been provided in detail, various changes, substitutions and alternations could be made thereto without departing from spirit and scope of the disclosed subject matter as defined by the appended claims. Variations described for the embodiments may be realized in any combination desirable for each particular application. Thus particular limitations and embodiment enhancements described herein, which may have particular advantages to a particular application, need not be used for all applications. Also, not all limitations need be implemented in methods, systems, and apparatuses including one or more concepts described with relation to the provided embodiments. Therefore, the invention properly is to be construed with reference to the claims.

References
[1] BISHOP, C. Neural networks for pattern recognition. Oxford University Press, 1995.
[2] BISHOP, C. Pattern recognition and machine learning. Information science and statistics. Springer, 2006.
[3] CLEVELAND, W. Robust locally weighted regression and smoothing scatterplots. Journal of the American statistical association (1979), 829-836.
[4] DAVIES, E. Machine vision: theory, algorithms, practicalities. Signal Processing and its Applications. Elsevier, 2005.
[5] FLUSSER, J., SUK, T., and ZITOVA, B. Moments and Moment Invariants in Pattern Recognition. John Wiley & Sons, 2009.
[6] FORNEY J R, G. The Viterbi algorithm. Proceedings of the IEEE 61, 3 (1973), 268-278.
[7] GIBSON, C. Elementary Euclidean geometry: an introduction. Cambridge University Press, 2003.
[8] HEALTH AND SAFETY EXECUTIVE STAFF. Ergonomics of Using a Mouse or Other Non-Keyboard Input Device. Research Report Series. HSE Books, 2002.
[9] IGEL, C., and HUSKEN, M. Improving the RPROP learning algorithm. In Proceedings of the second international ICS symposium on neural computation (NC 2000) (2000), pp. 115-121.
[10] KALMAN, R., E T AL. A new approach to linear filtering and prediction problems. Journal of basic Engineering 82, 1 (1960), 35-45.
[11] KITS USA. OWI-RTC007 Robotic Arm Curriculum. KITS USA, 2011.
[12] LIM, S. E. U.S. patent application Ser. No. 12/511,930: Control of

Computer Window Systems, Computer Applications, and Web Applications via High Dimensional Touch-pad User Interface.
[13] LIM, S. E. U.S. patent application Ser. No. 13/198,691: High-Dimensional Touchpad Game Controller with Multiple Usage and Networking Modalities.
[14] LIM, S. E. U.S. patent application Ser. No. 12/511,930: Control of Computer Window Systems, Computer Applications, and Web Applications via High Dimensional Touch-pad User Interface.
[15] LUDWIG, L. F. U.S. patent application Ser. No. 11/761,978: High Parameter-Count Touchpad Controller.
[16] LUDWIG, L. F. U.S. patent application Ser. No. 12/875,128: Interactive Data Visualization Utilizing HDTP Touchpad, HDTP. Touchscreens, Advanced Multitouch, or Advanced Mice.
[17] LUDWIG, L. F. U.S. patent application Ser. No. 12/618,698: Electronic Document Editing Employing Multiple Cursors.
[18] LUDWIG, L. F. U.S. patent application Ser. No. 12/619,678: User Interface Mouse with Touchpad Responsive to Gestures and Multi-Touch.
[19] LUDWIG, L. F. U.S. patent application Ser. No. 12/724,413: High-Performance Closed-Form Single-Scan Calculation of Oblong-Shape Rotation Angles from Binary Images of Arbitrary Size Using Running Sums.
[20] LUDWIG, L. F. U.S. patent application Ser. No. 13/026,097: Window Manger Input Focus Control for High Dimensional Touchpad (HDTP), Advanced Mice, and Other Multidimensional User Interfaces.
[21] LUDWIG, L. F. U.S. patent application Ser. No. 13/093,834: Piecewise-Linear and Piecewise-Affine Transformations for High Dimensional Touchpad (HDTP) Output Decoupling and Corrections
[22] LUDWIG, L. F. U.S. patent application Ser. No. 13/464,946: Simple Touch Interface and HDTP Grammars for Rapid Operation of Physical Computer Aided Design (CAD) Systems.
[23] LUDWIG, L. F. Provisional U.S. Patent Application 61/506,634: Use of OLED Displays as a High-Resolution Optical Tactile Sensor for High Dimensional Touchpad (HDTP) User Interfaces.
[24] LUDWIG, L. F. U.S. Pat. No. 7,620,915: Electronic Document Editing Employing Multiple Cursors.
[25] LUDWIG, L. F. U.S. Pat. No. 6,570,078: Tactile, Visual, and Array Controllers for Real-Time Control of Music Signal Processing, Mixing, Video, and Lighting.
[26] LUDWIG, L. F. U.S. Pat. No. 7,408,108: Multiple-Parameter Instrument Keyboard Combining Key-Surface Touch and Key-Displacement Sensor Arrays.
[27] LUDWIG, L. F. U.S. Pat. No. 7,557,797: Mouse-Based User Interface Device Providing Multiple Parameters and Modalities.
[28] LUDWIG, L. F., and HU, V. U.S. patent application Ser. No. 12/026,248: Enhanced Roll-Over, Button, Menu, Slider, and Hyperlink Environments for High Dimensional Touchpad (HDTP), Other Advanced Touch User Interfaces, and Advanced Mice
[29] LUDWIG, L. F., and LIM, S. E. U.S. patent application Ser. No. 12/418,605: Multi-Parameter Extraction Algorithms For Tactile Images From User Interface Tactile Sensor Arrays.
[30] LUDWIG, L. F., and ZALIVA, V. U.S. patent application Ser. No. 13/356,578: USB HID Device Abstraction for HDTP User Interfaces.
[31] LUDWIG, L. F, U.S. patent application Ser. No. 13/414,705: General User Interface Gesture Lexicon and Grammar Frameworks for Multi-Touch, High Dimensional Touch Pad (HDTP), Free-Space Camera, and Other User Interfaces.
[32] NGUYEN, N. and GUO, Y. Comparisons of sequence labeling algorithms and extensions. In Proceedings of the 24^{th} international conference on Machine Learning (2007), ACM, pp. 681-688.
[33] NISSEN, S. Implementation of a fast artificial neural network library (FANN). Tech. rep., Report, Department of Computer Science University of Copenhagen (DIKU), 2003.
[34] WEST, P., Provisional U.S. Patent Application 61/567,623: Heuristics for 3D and 6D Touch Gesture Recognition and Touch Parameter Measurements for High-Dimensional Touch Parameter (HDTP) User Interfaces.
[35] ZWEIG, G., and NGUYEN, P. SCARF: a segmental conditional random field toolkit for speech recognition. In Eleventh Annual Conference of the International Speech Communication Association (2010).
[36] OTSU, N. A threshold selection method from gray-level histograms. Automatica 11 (1975), 285-296.
[37] SIMON, S., and GRAHAM, A. U.S. patent application Ser. No. 13/009,845: Use of Fingerprint Scanning Sensor Data to Detect Finger Roll and Pitch Angles.
[38] SIMON, S. H., and GRAHAM, A. U.S. patent application Ser. No. 12/541,948: Sensors, Algorithms and Applications for a High Dimensional Touchpad.
[39] SONKA, M., HLAVAC, V., and BOYLE, R. Image processing, analysis, and machine vision. Thompson Learning, 2008.
[40] STATSOFT. Electronic statistics textbook. http://www.statsoft.com/textbook/, 2011. [Online; accessed 1-Jul.-2011].
[41] TANGUAY JR, D. Hidden Markov models for gesture recognition. Master's thesis, Massachusetts Institute of Technology, 1995.
[42] WACHS, J .P., KOLSCH, M., STERN, H., and EDAN, Y. Vision-based hand-gesture applications. Commun. ACM 54 (February 2011), 60-71.
[43] WELCH, L. Hidden Markov models and the Baum-Welch algorithm. IEEE Information Theory Society Newsletter 53, 4 (2003), 1-10.
[44] YANG, J., XU, Y., and CARNEGIE-MELLON UNIVERSITY.

ROBOTICS INSTITUTE. Hidden Markov model for gesture recognition. Tech. rep., Carnegie Mellon University. Robotics Institute, 1994.
[45] ZALIVA, V. OWI robotic arm edge USB protocol and sample code. http://notbrainsumery.livejournal.com/38622.html, 2010. [Online; accessed 11-Jul.-2011].
[46] ZALIVA, V. U.S. patent application Ser. No. 12/038,365: Touch-Based User Interfaces Employing Artificial Neural Networks for HDTP Parameter and Symbol Derivation.
[47] ZALIVA, V. U.S. patent application Ser. No. 13/038,372: Curve-fitting Approach to HDTP Parameter Extraction.
[48] ZALIVA, V. U.S. patent application Ser. No. 13/180,512: Sequential Classification Recognition of Gesture Primitives and Window-Based Parameter Smoothing For High Dimensional Touchpad (HDTP) User Interfaces.

1. A system for 3D gesture recognition on touch surfaces, the system comprising:
a touch user interface device including a sensor array configured to sense finger contact information associated with one or more regions of contact providing the finger contact information in the form of a stream of frame data; and
a processing device in communication with the touch user interface device configured to:
read frame data from the sensor array;
produce modified frame data by performing thresholding and normalization operations on the frame data,
produce a features vector by extracting at least one feature from the modified frame data;
create a gesture trajectory in a multi-dimensional gesture space wherein the multi-dimensional gesture space comprises a plurality of feature vectors, and wherein the gesture trajectory is a sequence of transitions between regions of the multi-dimensional gesture space;
detect a specific gesture; and
generate a control signal in response to the specific gesture.

2. The system of claim 1, wherein the processing device is further configured to implement a principle component analysis operation.

3. The system of claim 1, wherein the processing device is further configured to implement a Kalman filter operation.

4. The system of claim 1, wherein the multi-dimensional gesture space comprises a desired set of features, each feature represented by an associated dimension in the gesture space.

5. The system of claim 1, wherein the extraction of at least one feature further comprises high performance segmentation using Connected Component Labeling with subsequent label merging employing a Hausdorff metric is used to implement multi-touch capabilities.

6. The system of claim 1, wherein the extraction of at least one feature further comprises high performance segmentation with subsequent label merging employing a metric similar to but differing from a Hausdorff metric is used to implement multi-touch capabilities.
